(19) United States
(12) Patent Application Publication
(10) Pub. No.: US 2005/0230128 A1
(43) Pub. Date: Oct. 20, 2005

(54) Replaceable trench blade

(76) Inventors: Bret A. Smith, Pinckney, MI (US); David C. Ostrander, Stockbridge, MI (US)

Correspondence Address: HARNESS, DICKEY & PIERCE, P.L.C., P.O. BOX 828, BLOOMFIELD HILLS, MI, 48303, US

(21) Appl. No.: 11/085,007

(22) Filed: Mar. 18, 2005

Related U.S. Application Data
(60) Provisional application No. 60/560,008, filed on Apr. 6, 2004.

(51) Int. Cl. A01B 23/00

(52) U.S. Cl. 172/772.5

(57) ABSTRACT

A trench blade having a unitary interchangeable leading edge, providing for the rapid replacement during usage. The blade is comprised of a steel body for attachment to a trench digging apparatus, wherein a replaceable hardened-steel front edge is mounted, allowing for the replacement thereof when the edge become worn or broken during over time. The edge is attached to the blade in a manner which allows the user to remove and replace the edge quickly and easily within a short period of time without removing the entire blade assembly from the trenching apparatus, thereby eliminating down time of the machine and improving job efficiency.

### FIELD OF THE INVENTION

The present invention relates to a trench digging apparatus. More particularly, this invention relates to a trench digging apparatus which utilize an earth-penetrating blade for creating a trench or installing underground conduits, featuring an easily serviceable/replaceable blade.

### BACKGROUND OF THE INVENTION

Earth digging and trenching apparatuses have been around for a long time and are designed to make short work of creating holes and trenches in the earth, soil, sand in comparison to manual digging with shovels and spades. Though there have been many variations and implementations over time to obtain such results, one of the most useful means for creating an elongated trench of a given distance comprises utilizing some type of land vehicle such as a tractor which has an earth penetrating means having a blade either pushed in front of it, or dragged behind it as it traverses the soil.

By dragging the blade subterraneously as it moves along the surface of the ground, it can create a vertical trench of a predetermined depth, or can even draw a conduit for irrigation, electrical supply, fiber optic line or the like through the trench simultaneous to creating the trench itself, significantly cutting down on cost and labor.

Because the soil of the earth is rarely consistent through any given application, various debris such as clay, sand, metal scraps and rocks of various sizes often come in contact with the trench blade. All of these result in significant wear to the blade, especially the leading edge thereby requiring the entire blade to be resharpened/replaced, sometimes frequently depending on the type of soil and how often the blade is used. Replacing the entire blade is a significant undertaking, and requires significant downtime for the machine, since the blade must be completely removed from the earth penetrating means of the vehicle prior to changeover.

Since it is the leading edge of the blade which incurs the most wear and abrasion, it seems logical to have a trench digging blade wherein the leading edge can be replaced separate from the entire blade, and without having to disassemble the entire blade from the trench digging apparatus.

U.S. Pat. No. 5,119,888 to Hall, discloses a Replaceable edge for a trenching plow blade, comprising a plurality of front-edge sections which attach to a mounting rod to be welded on the leading edge of the blade. The drawback to this design comes in having the leading edge comprised of a plurality of sections, this in conjunction with requiring a mounting rod to be welded to the blade lowers the integrity of the edge, which endures severe strains and impacts from various rocks and debris while in use. This could result in one or more sections prematurely being broke off from the trench blade, impairing its efficiency.

There is thus a need for a trench blade having a replaceable, unitary leading edge for increased durability, allowing for the quick replacement thereof without having to remove the entire blade from the machine, thereby reducing the downtime, and increasing overall project efficiency.

### SUMMARY OF THE INVENTION

The present invention comprises a trench digging blade for attachment to a trenching apparatus of a vehicle, such as those depicted in the accompanying figures and known in the field of ground excavation. The blade is comprised of hardened steel or an alloy thereof and has an elongated, planar shape for extending down into the earth a predetermined depth by way of the trenching apparatus attached to the vehicle. The front edge of the blade, having a sharpened leading edge and also comprised of hardened steel or an alloy thereof is replaceable as a single unit.

The replaceable edge is attached to the leading edge of the blade by means of machine hardware or locking pins, through corresponding mounting holes located in the blade and the replaceable edge. The edge further wraps around the earth engaging end of the blade, and extends a predetermined distance downward beyond the blade terminating in a pointed edge, for penetrating the ground during use. Overall downtime is minimized due to the edge being of a single piece, easily replaced without removing the entire blade from the trenching apparatus.

### BRIEF DESCRIPTION OF THE DRAWINGS

The present invention will become more fully understood from the detailed description and the accompanying drawings, wherein:

FIG. 1 is a partial side view of a trench digging machine having a first embodiment of the trench digging blade and removable edge attached thereto;

FIG. 2 is a side view of the trench blade of FIG. 1, showing the replaceable edge attached to the blade;

FIG. 3 is a side view of the replaceable edge of FIG. 2 unattached to the trench blade;

FIG. 4 is a side view of the trench blade of FIG. 2 without the replaceable edge attached thereto;

FIG. 5 is a partial side view of a trench digging machine having a second embodiment of the trench digging blade and removable edge attached thereto;

FIG. 6 is a side view of the trench blade of FIG. 5, showing the replaceable edge attached to the blade;

FIG. 7 is a is a side view of the replaceable edge of FIG. 6 unattached to the trench blade; and

FIG. 8 is a side view of the trench blade of FIG. 6 without the replaceable edge attached thereto.

### DETAILED DESCRIPTION OF THE PREFERRED EMBODIMENTS

The following description of the preferred embodiments is merely exemplary in nature and is in no way intended to limit the invention, its application, or uses.

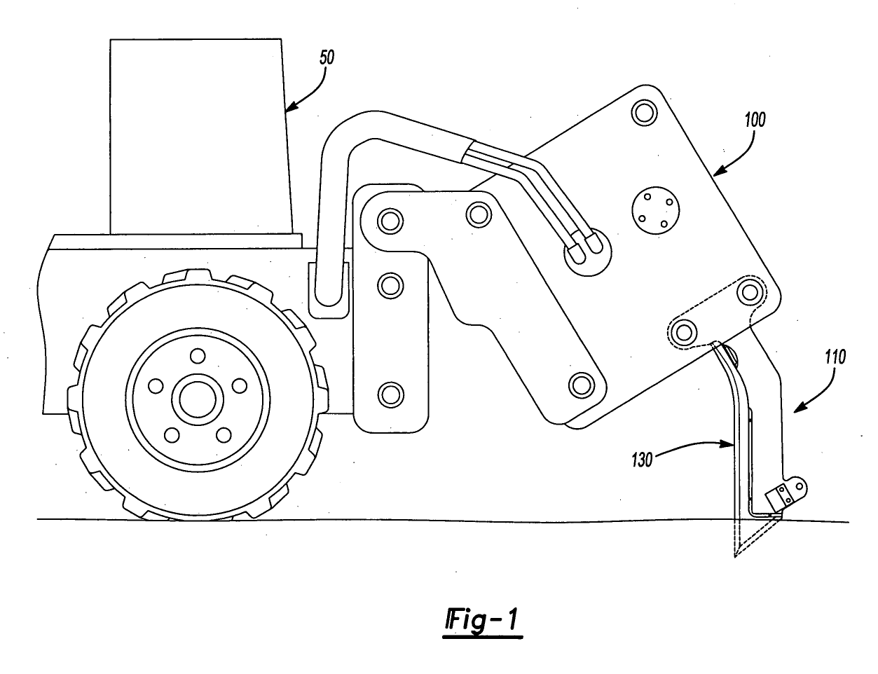

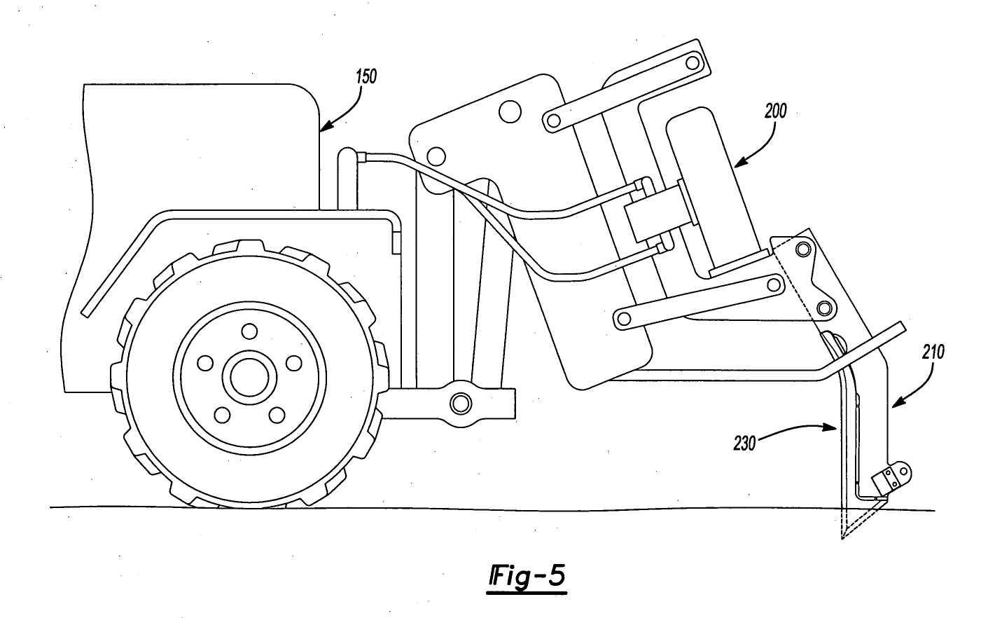

Referring to FIGS. 1 and 5, two variations are shown of trench digging vehicles 50 and 150 respectively, each having a manipulative trenching apparatus 100 and 200 attached thereto. FIG. 1 illustrates a trenching apparatus 100 having a first embodiment of the trench blade assembly 110 with replaceable edge 130 attached there to, while FIG. 5 illustrates a trenching apparatus 200 having a second embodiment of the trench blade assembly 210 with replaceable edge 230 attached thereto. Both embodiments function in substantially similar ways, and vary only in respect to their attachment means to the different trenching apparatuses 100 and 200, depending on the specific one implemented on a given vehicle 50 or 150.

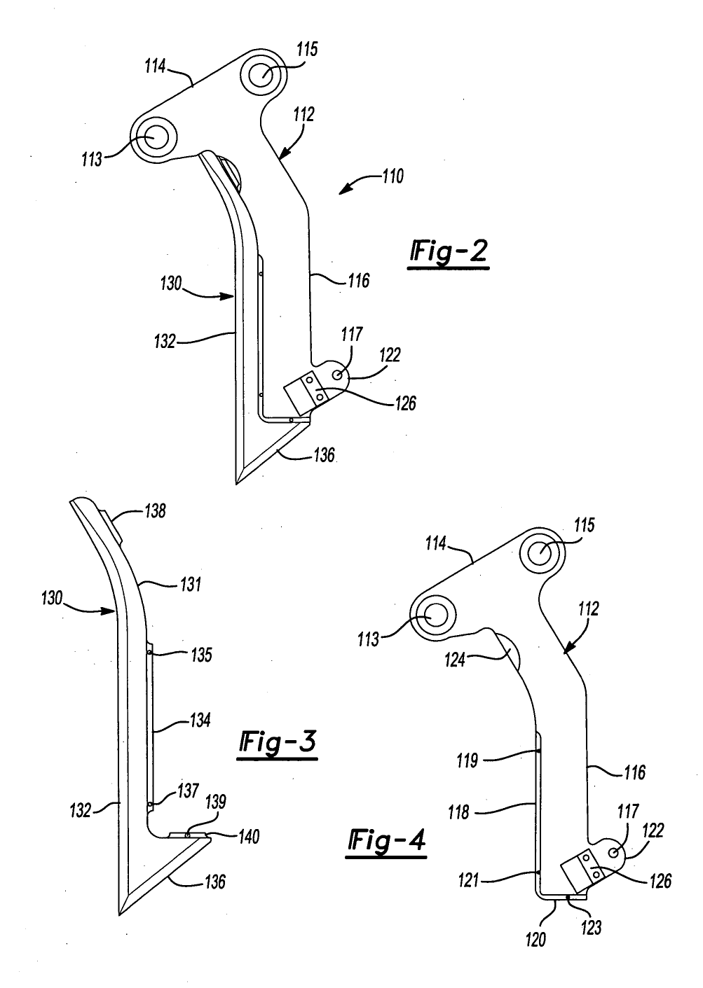

As shown in FIGS. 1-4 illustrating the first embodiment of the trench blade assembly 110, the present invention comprises two primary components; a trench blade 112 and a replaceable edge 130. Shown combined in FIG. 2 with the replaceable edge 130 but isolated for illustration purposes in FIG. 4, the trench blade 112 is formed of steel or a hardened alloy thereof and has a generally planar, elongated shape with an upper attachment end 114, an earth penetrating end 120, leading edge 118 and trailing edge 116. The body of the blade 112 is angled, providing for better earth penetration, and improving the blades subterraneous angle of attack.

In this first embodiment the attachment end 114 of the blade 112 is T-shaped, having spaced apart mounting apertures 113 and 115 there through for attachment to the trenching apparatus 100. The earth penetrating end 120 further comprises a coplanar rear-projecting attachment tab 122 having aperture 117 there through, for attachment to a cable, wire, conduit or the like which may be simultaneously fed through the trench as the blade assembly 110 traverses through the earth. Additionally, a replaceable, forward facing inclined wedge element 126 is attached to the blade 112 on one or both sides of the blade 112 directly before the accessory aperture 117 diverting the ground and thereby reducing the frictional drag of any conduit being pulled through the ground, while also protecting the leading end of any conduit against damage from subterraneous debris.

Referring now to FIG. 3, the replaceable edge 130 of the trench blade assembly 110 is a unitary, generally L-shaped element formed of hardened steel and extending along, and attaching to the leading edge 118 of the trench blade 112. The replaceable edge 130 has a lower end which extends beyond the earth penetrating end 120 of the blade 112 terminating in a point 136, thereby aiding in penetrating the ground. The trailing edge of the point 136 extends back along the earth penetrating end 120 of the blade 112 and terminates proximal the trailing edge 116 of the blade. Both the front side 132 and point 136 are beveled to a sharpened edge, providing for easier subterraneous movement of the blade assembly 110.

The back side 131 of the replaceable edge 130 comprises mounting tabs 134,138 and 140, having attachment apertures 135, 137, and 139 there through, which associate with and attach to mounting portion 124 and front edge 118 of the blade 112 through apertures 119, 121, and 123 therein. The attachment hardware utilized may be any removable hardened machine screws or locking pin arrangement which provides a secure attachment through the corresponding apertures to attach the replaceable edge 130 to the blade 112, but can easily be removed once the replaceable edge is worn and requires refurbishing or replacement.

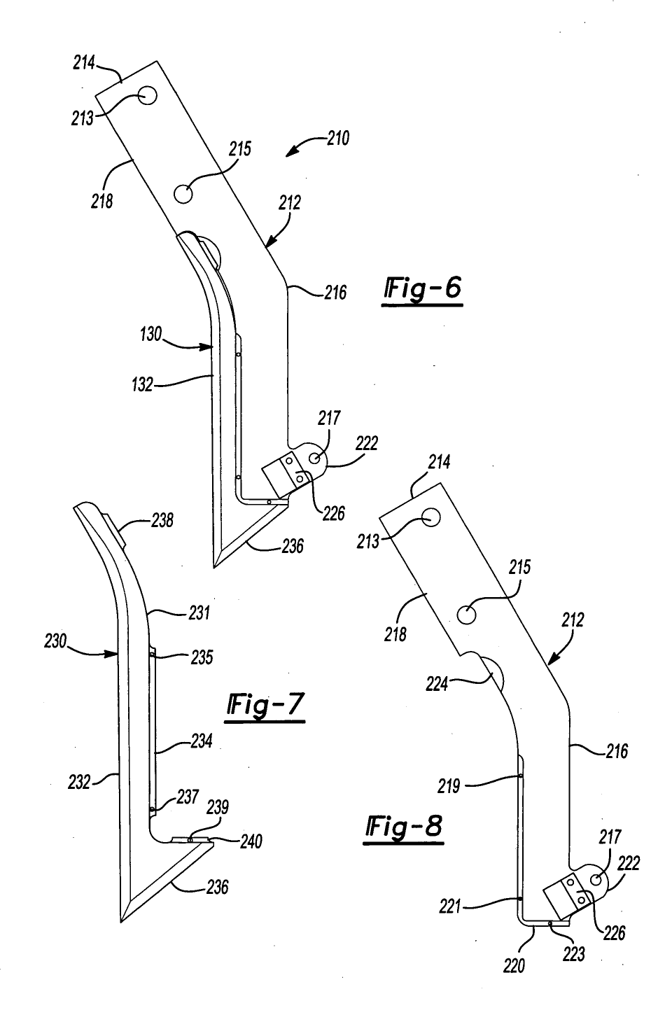

Now referring to FIGS. 5-8, similar in function to the first embodiment of the trench blade assembly 110, the second embodiment also comprises two primary components; a trench blade 212 and a replaceable edge 130. Shown combined in FIG. 6 with the replaceable edge 230 but isolated for the purpose of illustration in FIG. 8, the trench blade 212 is formed of steel or a hardened alloy thereof and has a generally planar, elongated shape with an upper attachment end 114, an earth penetrating end 220, leading edge 218 and trailing edge 216. The body of the blade 212 is angled, providing for better earth penetration, and improving the blades subterraneous angle of attack.

In this second embodiment the attachment end 214 of the blade 212 has longitudinally spaced apart mounting apertures 213 and 215 there through for attachment to the trenching apparatus 200. The earth penetrating end 220 further comprises a coplanar rear-projecting attachment tab 222 having aperture 217 there through, for attachment to a cable, wire, conduit or the like which may be simultaneously fed through the created trench as the blade assembly 210 traverses through the earth. Additionally, a forward facing inclined wedge element 226 is replaceably attached to the blade 212 on one or both sides of the blade 212 directly before the accessory aperture 217 diverting the ground, thereby reducing the frictional drag of any conduit being pulled through the ground while also protecting the leading end of any conduit against damage from subterraneous debris.

Referring now to FIG. 7, the replaceable edge 230 of the trench blade assembly 210 is a unitary, generally L-shaped element formed of hardened steel and extending along, and attaching to the leading edge 218 of the trench blade 212. The replaceable edge 230 has a lower end which extends beyond the earth penetrating end 220 of the blade 212 terminating in a point 236, thereby aiding in penetrating the ground. The trailing edge of the point 236 extends back along the earth penetrating end 220 of the blade 212 and terminates proximal the trailing edge 216 of the blade. Both the front side 132 and point 136 are beveled to a sharpened edge providing for easier subterraneous movement of the blade assembly 210.

The back side 231 of the replaceable edge 230 comprises a mounting tabs 234, 238 and 240, having attachment apertures 235, 237, and 239 there through, which associate with and attach to mounting portion 124 and front edge 218 of the blade 212 through apertures 219, 221, and 223 therein. The attachment hardware utilized may be any removable hardened machine screws or locking pin arrangement which provides a secure attachment through the corresponding apertures to attach the replaceable edge 230 to the blade 212, but can easily be removed once the replaceable edge is worn and requires refurbishing or replacement.

In both embodiments described above, the replaceable edges 130/230 are single, unitary formed elements, which provide greater strength and resistance from impacts with subterraneous debris, and allow for a more rapid change out when replacement is needed. When such an event is required, the user simply manipulates the trenching apparatus 100/200 out of the ground so as to expose the entire blade assembly 110/210. Without removing the assembly 110/210 from the corresponding trenching apparatus, the user can remove the hardware attaching the replaceable edge 130/230, to the blade 112/212; replace the worn edge with a new or refurbished edge 130/230 utilizing either the original or new hardware, and return the trench blade assembly back into the ground to continue trenching with just a brief downtime delay, thereby significantly increasing efficiency.

The description of the invention is merely exemplary in nature and, thus, variations that do not depart from the gist of the invention are intended to be within the scope of the invention. Such variations are not to be regarded as a departure from the spirit and scope of the invention.

1. A trench-digging blade assembly having a replaceable edge, comprising:
an elongated, angled planar steel blade for attaching to a trench-digging machine, said blade having a mounting end attaching to a trenching machine, an earth engaging end opposite said mounting end, a leading end and a trailing end, said leading end having an interface portion with a plurality of spaced apart apertures through said interface portion a predetermined distance from said leading end for mounting a detachable steel edge, said edge having a complementary interface portion with corresponding apertures aligning with said apertures through said blade, for releasably attaching said edge to said leading end of said blade.

2. The trench-digging blade assembly of claim 1 wherein said blade further comprises an extending tab, extending coplanarly from said trailing end with at least one draw aperture a predetermined distance from said earth engaging end, proximal said trailing end for attaching the end of a conduit to be pulled through the ground.

3. The trench-digging blade assembly of claim 2 wherein said blade has at least one lateral earth-diverting wedge attached to at least one side of said blade in front of said draw aperture.

4. The trench-digging blade assembly of claim 1 wherein said detachable steel edge has a beveled, sharpened leading edge running the length of said detachable steel edge, opposite said interface portion.

5. The trench-digging blade assembly of claim 4 wherein said detachable steel edge extends around said earth engaging end of said blade.

6. The trench-digging blade assembly of claim 5 wherein said detachable steel edge extends downward beyond said earth engaging end of said blade a predetermined distance terminating in a point.

7. The trench-digging blade assembly of claim 6 wherein said detachable steel edge can be removed as a single element from said blade and replaced while said blade is mounted to said trenching machine.

8. A trench-digging blade assembly having a replaceable edge, comprising:
an elongated, angled planar steel blade for attaching to a trench-digging machine, said blade having a mounting end, an earth engaging end opposite said mounting end, a leading end and a trailing end, said leading end having an interface portion with a plurality of spaced apart apertures through said interface portion a predetermined distance from said leading end for mounting a detachable steel edge, said edge having a complementary interface portion with corresponding apertures aligning with said apertures through said blade, for releasably attaching said edge to said leading end of said blade, said detachable steel edge having a beveled, sharpened leading edge running the length of said detachable steel edge, opposite said interface portion,
said earth-engaging end of said blade having an extending tab extending coplanarly from said trailing end with at least one draw aperture a predetermined distance from said earth engaging end, proximal said trailing end, said detachable steel edge extending around the bottom of said earth engaging end of said blade; said edge extending downward beyond said earth engaging end of said blade a predetermined distance, terminating in a point.

9. The trench-digging blade assembly of claim 8 wherein said detachable steel edge can be removed as a single element from said blade and replaced while said blade is mounted to said trenching machine.
